(19) United States
(12) Patent Application Publication
(10) Pub. No.: US 2025/0193850 A1
(43) Pub. Date: Jun. 12, 2025

(54) METHOD OF WIRELESS COMMUNICATION AND IN-VEHICLE WIRELESS COMMUNICATION SYSTEM

(71) Applicant: Wistron NeWeb Corp., Hsinchu (TW)

(72) Inventors: Wen-Hsiang WU, Hsinchu (TW); Cheng-Jung WEN, Hsinchu (TW); Wen-Jin LEE, Hsinchu (TW)

(21) Appl. No.: 18/947,279

(22) Filed: Nov. 14, 2024

(30) Foreign Application Priority Data
Dec. 6, 2023 (TW) 112147430

(51) Int. Cl. H04W 72/04; G07C 5/00; G07C 5/02; H04W 88/08

(52) U.S. Cl. CPC H04W 72/04; G07C 5/008; G07C 5/02; H04W 88/08

(57) ABSTRACT

A method of wireless communication is provided. The method includes receiving, via a control unit mounted on a vehicle, at least one driving parameter of the vehicle. The method further includes determining, via the control unit, whether a condition is met according to the driving parameter. The method further includes controlling, via the control unit, a wireless connection module mounted on the vehicle to perform automatic channel selection (ACS), when the control unit determines that the condition is met. The condition includes that the vehicle is in an idle state.

### CROSS REFERENCE TO RELATED APPLICATIONS

This application claims priority of Taiwan Patent Application No. 112147430, filed on Dec. 6, 2023, the entirety of which is incorporated by reference herein.

### BACKGROUND OF THE DISCLOSURE

### Field of the Disclosure

The present disclosure relates to methods of wireless communication, and, in particular, to methods for an in-vehicle wireless communication system.

### Description of the Related Art

Many modern vehicles are equipped with Wi-Fi routers capable of offering a Wi-Fi hot spot. Home-use Wi-Fi routers have an automatic channel selection (ACS) function. ACS is a function/process that selects a channel with low interference from the available channels by scanning all available channels. However, when the Wi-Fi router is mounted on a vehicle, the Wi-Fi router will receive interference from the environment surrounding the vehicle. Referring to FIG. 1, vehicle A1 receives interference I1 from vehicle A2, interference I2 from vehicle A3, interference I3 from building B1, and interference I4 from building B2. For example, interference I1˜I4 are co-channel interference caused by user equipment (UE) or access points (AP) in vehicles A2, A3 and buildings B1, B2. Furthermore, in the scenario that the Wi-Fi router is mounted on the vehicle, interference received by the Wi-Fi router varies as the vehicle moves. However, the current design of Wi-Fi routers doesn't take the above factors into consideration. Moreover, it is difficult for a user without the relevant knowledge to find a relatively stable channel by manually setting up the Wi-Fi router.

Thus, how to activate the ACS function of an in-vehicle Wi-Fi router with proper timing is one of the problems to be solved in this field.

### BRIEF SUMMARY OF THE DISCLOSURE

An embodiment of the present disclosure provides a method of wireless communication. The method includes receiving, via a control unit mounted on a vehicle, at least one driving parameter of the vehicle. The method further includes determining, via the control unit, whether a condition is met according to the driving parameter. The method further includes controlling, via the control unit, a wireless connection module mounted on the vehicle to perform automatic channel selection (ACS), when the control unit determines that the condition is met. The condition includes that the vehicle is in an idle state.

In some embodiments, the driving parameters may include speed, acceleration, or engine speed of the vehicle. In some embodiments, the condition further includes that the vehicle switches to the idle state from the driving state.

In some embodiments, the control unit determines that the vehicle is in the idle state in response to a determination that the driving parameter is lower than a threshold for more than a specific period of time and the vehicle is not stalled. The control unit determines that the vehicle is in the driving state in response to a determination that the driving parameter is higher than the threshold.

In some embodiments, the control unit determines whether the vehicle switches from the driving state to the idle state according to the previous state stored in memory. The previous state is the state that the vehicle was in before a period of time, and the previous state is the idle state or the driving state.

An embodiment of the present disclosure provides an in-vehicle wireless communication system, which is mounted on a vehicle. The in-vehicle wireless communication system includes a wireless connection module and a control unit. The control unit is configured to receive at least one driving parameter of the vehicle. The control unit is further configured to determine whether a condition is met according to the driving parameter, and to control the wireless connection module to perform automatic channel selection (ACS), when determining that the condition is met. The condition includes that the vehicle is in an idle state.

In some embodiments, the control unit receives the driving parameter from an on-board diagnostic, a sensor, or a global positioning system.

### BRIEF DESCRIPTION OF THE DRAWINGS

The present disclosure can be more fully understood by reading the subsequent detailed description and examples with references made to the accompanying drawings, wherein:

FIG. 1 is a schematic diagram of the example scene;

FIG. 2 is a block diagram of an in-vehicle wireless communication system in accordance with the embodiments of the present disclosure;

FIG. 3 is a flow diagram of the method of a wireless communication in accordance with the embodiments of the present disclosure; and

FIGS. 4A and 4B are charts in accordance with embodiments of the present disclosure;

FIG. 5 is a flow diagram of method of wireless communication in accordance with the embodiments of the present disclosure.

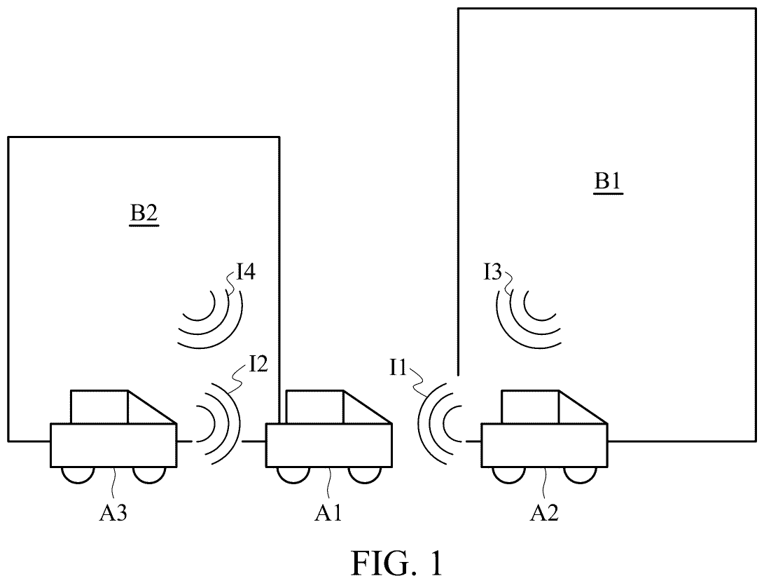

### DETAILED DESCRIPTION OF THE DISCLOSURE

The following description is made for the purpose of illustrating the general principles of the disclosure and should not be taken in a limiting sense. The scope of the disclosure is best determined by reference to the appended claims.

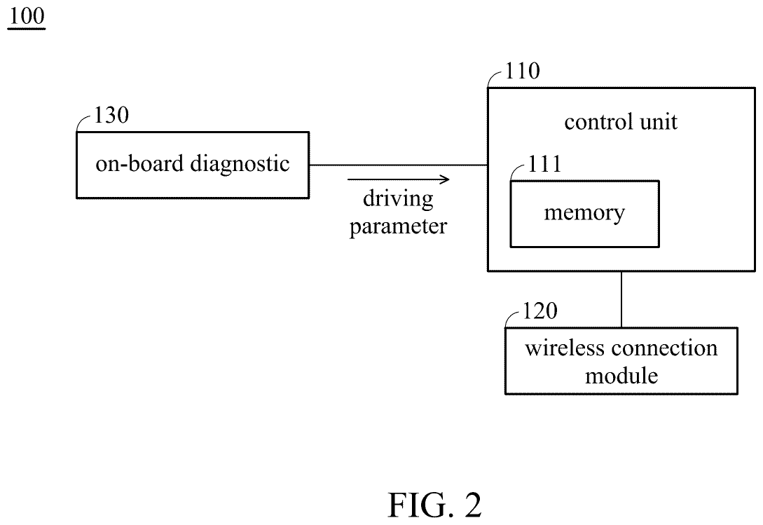

Referring to FIG. 2, FIG. 2 is a block diagram of an in-vehicle wireless communication system 100 in accordance with the embodiments of the present disclosure. The in-vehicle wireless communication system 100 includes a control unit 110, a wireless connection module 120, and an on-board diagnostic 130. The in-vehicle wireless communication system 100 is mounted on a vehicle VE (not shown). The vehicle VE is, for example, but not limited to, buses and sedans etc.

The control unit 110 provides computation and process ability. The control unit 110 is able to perform programs, software, firmware, and modules. Moreover, the control unit 110 is configured to control wireless connection module 120 (e.g. using instructions). For example, the control unit 110 may include general purpose processor, special purpose processor, central process unit, and/or micro control unit. In some embodiments, the control unit 110 is an on-board computer.

The control unit 110 includes the memory 111. The memory 111 stores data required by the operations of the control unit 110. The control unit 110 is able to access and write to the memory 111. In some embodiments, the memory 111 stores program code. The program codes can be read and operated by the control unit 110 and cause the control unit 110 to implement the methods described below (such as method 200 and 300 of wireless communication). The memory 111 may include non-volatile memories, such as read only memory (ROM) and flash memory. The memory 111 may also include volatile memories, such as dynamic random access memory (DRAM) and static random access memory (SRAM).

The wireless connection module 120 provides the capability of wirelessly connecting to a network. The wireless connection module 120 is able to connect with at least one user equipment (such as mobile device, cell phone, and laptop computer). The user equipment may connect to the Internet through the wireless connection module 120. Furthermore, the wireless connection module 120 is capable of performing automatic channel selection (ACS). For example, the wireless connection module 120 is a chip or integrated circuit comprising a network card and/or subscriber identity module (SIM). In some embodiments, the wireless connection module 120 applies Wi-Fi technology. In some embodiments, the wireless connection module 120 is installed in the vehicle VE in a factory-installed manner. In other words, the wireless connection module 120 is installed in the vehicle VE in the production stage. In other embodiments, the wireless connection module 120 is installed in the vehicle VE in an aftermarket-installed manner. In other words, the wireless connection module 120 is installed externally in the vehicle VE after the vehicle leaves the factory. For example, the wireless connection module 120 is Wi-Fi router, Wi-Fi hot spot, Wi-Fi dongle, or wireless network access point. Although FIG. 2 shows that the wireless connection module 120 is separate from the control unit 110, the wireless connection module 120 may be one of the modules or chips of the control unit 110 and integrated in the control unit 110.

The on-board diagnostic (OBD) 130 is configured to provides the driving parameters of the vehicle VE to the control unit 110. For example, the driving parameters (the operation parameter of the vehicle) include, but not limited to, speed, acceleration, engine speed, and/or location of the vehicle VE. OBD 130 may receive the driving parameters from corresponding sensors. For example, the sensors is, but not limited to, speed sensor, G-sensor, tachometer.

It should be noted that the in-vehicle wireless communication system 100 may further includes other components not shown in FIG. 2, such as global positioning system (GPS), display device and/or user interface device. In some embodiments, the control unit 110 receives the driving parameters from the interfaces other than the OBD 130. For example, the control unit 110 may receive the driving parameters from a GPS on the vehicle VE, where the driving parameters may include location and/or speed, but are not limited thereto. Moreover, the control unit 110 may also directly receive the driving parameters from the sensors.

In some embodiments, the in-vehicle wireless communication system 100 is a mobile base station configured to provide wireless network connection to user equipment around the vehicle VE (i.e. outside the vehicle VE). In this embodiment, the in-vehicle wireless communication system 100 may further include antenna towers or antenna arrays.

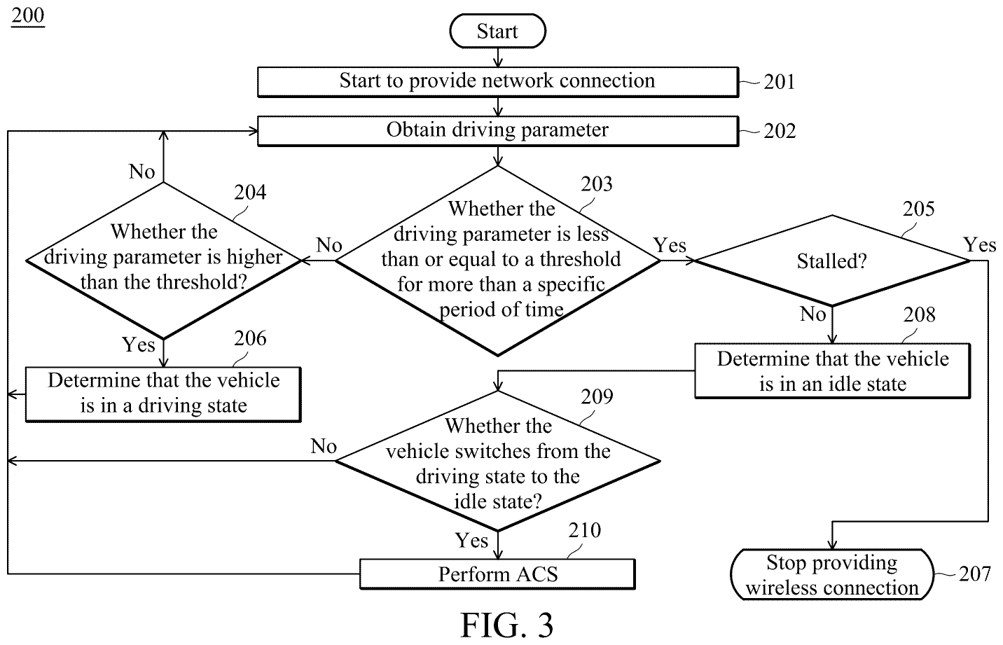

Referring to FIG. 3, FIG. 3 is a flow diagram of the method 200 of a wireless communication (also referred to as method 200) in accordance with the embodiments of the present disclosure. Method 200 can be implemented in the in-vehicle wireless communication system 100. Method 200 starts from operation 201. In operation 201, the wireless connection module 120 starts to provide network connection (to the in-vehicle user equipment). Operation 201 may be performed in response to the vehicle VE being activated, and/or the wireless connection module 120 being powered on. Optionally, the wireless connection module 120 performs ACS once in the operation 120. Then, the method 200 proceeds to operation 202.

In operation 202, the control unit 110 obtains the driving parameter of the vehicle VE. As mentioned above, the control unit 110 can receive the driving parameter of the vehicle VE from the OBD 130, GPS, and/or other interfaces. Then, the method 200 proceeds to operation 203. In operation 203, the control unit 110 determines whether the driving parameter of the vehicle VE is less than (or equal to) a threshold for more than a specific period of time (or a predetermined duration). As mentioned above, the driving parameter includes speed, acceleration, engine speed, and/or location of the vehicle VE. Each driving parameter corresponds to a different threshold. For example, the threshold corresponds to the engine speed is 500 revolution per minute (RPM). The threshold corresponds to the speed is 5 kilogram/hour (km/hr). The threshold corresponds to the acceleration is 0.5 meter/second² (m/s²). Moreover, the specific period of time is, for example, 5 seconds. Thus, in operation 203, the control unit 110 determines whether the engine speed is less than 500 RPM for more than 5 seconds, the speed is less than 5 km/hr for more than 5 seconds, and/or the acceleration is less than 0.5 m/s² for more than 5 seconds. In some embodiments, the control unit 110 determines whether the location of the vehicle VE remains the same for more than a specific period of time in operation 203. If no, the method 200 proceeds to operation 204. If yes, the method 200 proceeds to operation 205. It should be noted that the above values are merely examples and should not be a limitation of the present disclosure.

In operation 204, the control unit 110 determines whether the driving parameter of the vehicle VE is higher than the threshold. If yes, the method 200 proceeds to operation 206. If no, the method 200 goes back to operation 202. Similarly, different driving parameters correspond to different thresholds. Furthermore, thresholds used in operation 204 are identical to those used in operation 203. In some embodiments, the control unit 110 determines whether the location of the vehicle VE is changed in operation 204. In operation 206, the control unit 110 determines that the vehicle VE is in a driving state (moving state). Then, the method 200 goes back to operation 202. In the present disclosure, the driving state means that the vehicle is in motion (moving) and/or the speed of the vehicle is higher than the threshold.

In operation 205, the control unit 110 determines whether the vehicle VE is stalled or not. If yes, the method 200 proceeds to operation 207. If no, the method 200 proceeds to operation 208. The control unit 110 may obtain information of engine through OBD 130 and determine the vehicle VE is stalled based on this information. However, the present disclosure is not limited to this. In the present disclosure, stalled means the engine of the vehicle stops. However, when the vehicle is stalled, electronic devices in the vehicle can still run on other power sources, such as vehicle battery. In operation 207, the wireless connection module 120 stops providing wireless connection in response to the vehicle VE being stalled. In some embodiments, the control unit 110 controls the wireless connection module 120 to turn off using a command in operation 207.

In operation 208, the control unit 110 determines that the vehicle VE is in an idle state. In the present disclosure, idle state means a state in which the vehicle is not in motion and the engine is still running. The engine speed in the idle state is lower than the engine speed in the driving state. Then, the method 200 proceeds to operation 209. In operation 209, the control unit 110 determines whether the vehicle VE switches from the driving state to the idle state. If yes, the method 200 proceeds to operation 210. If no, the method 200 goes back to operation 202. In some embodiments, the control unit 110 stores the state of the vehicle VE (driving state or idle state) in the memory 111. In operation 209, the control unit 110 reads the previous state from the memory 110 so as to determine whether the vehicle VE switches from the driving state to the idle state based on the previous state. The previous state is the state that the vehicle VE was in before (performing operation 209) a period of time (i.e. the state of the vehicle VE at a time point before the current time point (performing operation 209) a period of time). For example, a period of time may be 5 seconds, 30 seconds, or 1 minute. Because the control unit 110 has ensured that the vehicle VE is in the idle state in operation 209, the control unit 110 determines that the vehicle VE switches from the driving state to the idle state, when the previous state is the driving state. In other embodiments, the control unit 110 periodically stores the driving parameters in the memory 111, and determines whether the vehicle VE switches from the driving state to the idle state based on the driving parameters in operation 209. The previous driving parameters are the driving parameters of the vehicle VE (performing operation 209) a period of time before. For example, a period of time may be 5 seconds, 30 seconds, or 1 minute.

In operation 210, the control unit 110 controls the wireless connection module 120 to perform ACS. For example, the wireless connection module 120 may select one channel from all the available channels according to the strength of the interference, number of UEs, the frequency on which the UE transmits and receives data, and the size of the data transmitted and received by the UE on each channel. However, the wireless connection module 120 may perform ACS using any algorithm known in the art. In some embodiments, the control unit 110 controls the wireless connection module not to perform ACS when the vehicle VE is in the driving state.

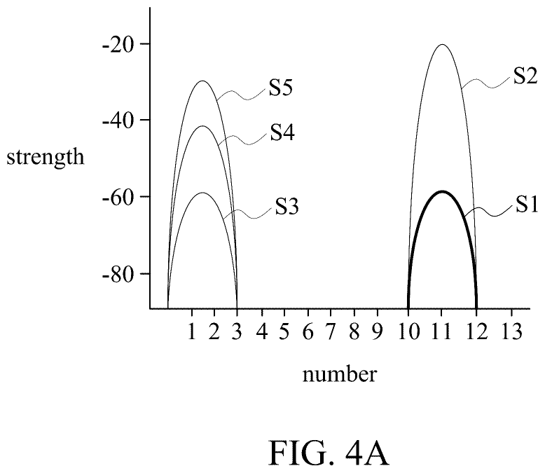

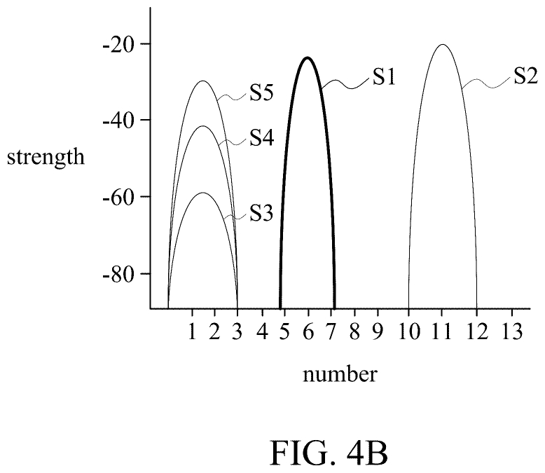

In some embodiments, the wireless connection module 120 changes the used channel after performing ACS (operation 210). Referring to FIGS. 4A and 4B, FIGS. 4A and 4B are charts in accordance with embodiments of the present disclosure. The vertical axes of the FIGS. 4A and 4B are the signal strength (unit: decibel (dB)), and the horizontal axes of the FIGS. 4A and 4B are the channel number. In FIGS. 4A and 4B, the signal S1 in bold is the signal of the wireless connection module 120, and signals S2˜S5 are signals from other devices. Referring to FIG. 4A, FIG. 4A illustrates the situation before performing ACS. In FIG. 4A, the wireless connection module 120 transmits and receives data on channel 11. Because signal S2 also transmits and receives data on channel 11, signal S2 is the co-channel interference for the wireless connection module 120. Referring to FIG. 4B, FIG. 4B illustrates the situation after performing ACS. After performing ACS, the wireless connection module 120 switches to channel 6 to transmit/receive data. Because there's no other devices using channel 6 (no other signals), the signal strength of the wireless connection module 120 increases comparing to the signal strength before performing ACS.

Thus, the embodiments of the present disclosure activate ACS when the vehicle is in the idle state. When the vehicle is moving, the surrounding environment will rapidly change, and the received interference will keep changing. At this time, even activating ACS and changing the channel used, the changed channel may also have low data transmission rate due to new interference. In other words, when the vehicle is moving, it is hard to find a channel having low interference/high transmission rate stably over a long period of time. On the contrary, when the vehicle is idling, the surrounding environment is stable. At this time, activating ACS can find a channel having low interference/high transmission rate stably over a long period of time. Moreover, the embodiments of the present disclosure activate ACS when the vehicle switches from the driving state to the idle state. Doing so can avoid performing ACS repeatedly when the vehicle stays in the idle state for a long time. Thus, embodiments of the present disclosure can activate ACS at a proper timing to ensure ACS has positive effect and increase user experience. That is, embodiments of the present disclosure can avoid performing unnecessary ACS or ACS with low expected benefits and thus can reduce power consumption.

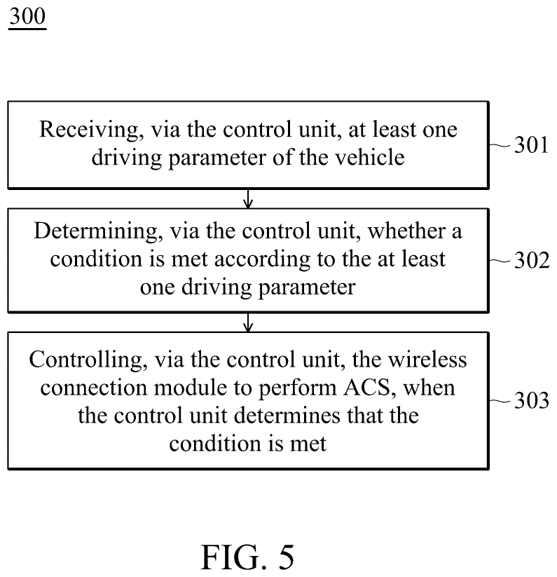

Referring to FIG. 5, FIG. 5 is a flow diagram of method 300 of wireless communication in accordance with the embodiments of the present disclosure. Method 300 can be implemented in the in-vehicle wireless communication system 100. Method 300 starts from operation 310. In operation 301, the control unit 101 receives at least one driving parameter of the vehicle VE. In operation 302, the control unit 110 determines whether a condition is met according to the driving parameter. In some embodiments, the condition includes that the vehicle VE is in an idle state. In some embodiments, the condition includes that the vehicle VE switches to the idle state from a driving state. In operation 303, the control unit 110 controls the wireless connection module 120 to perform ACS, when the control unit 110 determines that the condition is met.

While the disclosure has been described by way of example and in terms of the preferred embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of wireless communication, comprising:
receiving, via a control unit mounted on a vehicle, at least one driving parameter of the vehicle;
determining, via the control unit, whether a condition is met according to the at least one driving parameter; and
controlling, via the control unit, a wireless connection module mounted on the vehicle to perform automatic channel selection (ACS), when the control unit determines that the condition is met;
wherein the condition comprises that the vehicle is in an idle state.

2. The method of wireless communication as claimed in claim 1, wherein the at least one driving parameter comprises speed, acceleration, or engine speed of the vehicle.

3. The method of wireless communication as claimed in claim 1, wherein the condition further comprises that the vehicle switches to the idle state from a driving state.

4. The method of wireless communication as claimed in claim 3, wherein the control unit determines that the vehicle is in the idle state in response to a determination that the at least one driving parameter is lower than a threshold for more than a specific period of time and the vehicle is not stalled;
wherein the control unit determines that the vehicle is in the driving state in response to a determination that the at least one driving parameter is higher than the threshold.

5. The method of wireless communication as claimed in claim 3, wherein the control unit determines whether the vehicle switches from the driving state to the idle state according to a previous state stored in a memory;
wherein the previous state is the state that the vehicle was in before a period of time;
wherein the previous state is the idle state or the driving state.

6. An in-vehicle wireless communication system mounted on a vehicle, the in-vehicle wireless communication system comprises:
a wireless connection module; and
a control unit, configured to:
receive at least one driving parameter of the vehicle;
determine whether a condition is met according to the at least one driving parameter; and
control the wireless connection module to perform automatic channel selection (ACS), when the control unit determines that the condition is met;
wherein the condition comprises that the vehicle is in an idle state.

7. The in-vehicle wireless communication system as claimed in claim 6, wherein the at least one driving parameter comprises speed, acceleration, or engine speed of the vehicle.

8. The in-vehicle wireless communication system as claimed in claim 6, wherein the condition further comprises that the vehicle switches to the idle state from a driving state.

9. The in-vehicle wireless communication system as claimed in claim 8, wherein the control unit determines that the vehicle is in the idle state in response to a determination that the at least one driving parameter is lower than a threshold for more than a specific period of time and the vehicle is not stalled;
wherein the control unit determines that the vehicle is in the driving state in response to a determination that the at least one driving parameter is higher than the threshold.

10. The in-vehicle wireless communication system as claimed in claim 6, wherein the control unit receives the at least one driving parameter from an on-board diagnostic, a sensor, or a global positioning system.
